(19) United States
(12) Patent Application Publication
(10) Pub. No.: US 2012/0262443 A1
(43) Pub. Date: Oct. 18, 2012

(54) METHOD FOR FRAME SCANNING AND PIXEL STRUCTURE, ARRAY SUBSTRATE AND DISPLAY APPARATUS

(75) Inventor: Yanbing Wu, Beijing (CN)

(73) Assignee: BOE Technology Group Co., Ltd., Beijing (CN)

(21) Appl. No.: 13/446,446

(22) Filed: Apr. 13, 2012

(30) Foreign Application Priority Data
Apr. 14, 2011 (CN) 201110093837.1

(51) Int. Cl. G09G 3/36; G09G 5/00

(52) U.S. Cl. 345/215; 345/87

(57) ABSTRACT

Provided are a method for frame scanning pixel electrodes, a pixel structure, an array substrate and a display apparatus, each pixel electrode is divided into a charging pixel electrode and a displaying pixel electrode, the method comprising: charging respective charging pixel electrodes in a row-by-row scanning mode; and charging, by the charging pixel electrodes, their corresponding displaying pixel electrodes respectively when the scanning of one frame of picture is finished. With the present disclosure, the frame scanning is realized, thus improving the brightness in stereoscopic displaying in a line scanning mode and reducing occurrence of crosstalk in stereoscopic displaying in the line scanning mode.

### TECHNICAL FIELD OF THE DISCLOSURE

The present disclosure relates to the technical field of Liquid Crystal Display (LCD), and particularly to a method for frame scanning pixel electrodes, a pixel structure, an array substrate and a display apparatus.

### BACKGROUND

The Thin Film Transistor Liquid Crystal Display (TFT-LCD) is the most popular technology of panel displaying nowadays, the basic structure of a pixel thereof, as shown in FIG. 1, comprises: a gate electrode line (denoted by G1, G2 in the figure, with G1 indicating the gate electrode line corresponding to a first row of pixels and G2 indicating the gate electrode line corresponding to a second row of pixels), a signal line H, a triode circuit 11, a pixel electrode 12 and a common electrode 13. The pixel structure operates in a row scanning mode, that is, only one row of pixels can be scanned and charged at one time. Taking the pixel structure shown in FIG. 1 as an example, at a first timing, the gate electrode line G1 is input a high voltage, the gate electrodes of the triode circuits 11 of the pixels of the row corresponding to G1 are turned on, and the signal line H inputs a signal voltage to the pixel electrode 12 through the triode circuit 11. The signal voltage on the pixel electrode 12 and the common voltage on the common electrode 13 forms a pixel electric filed controlling liquid crystal molecules on the pixel to deflect, and thus displaying is realized. At a second timing, the gate electrode line G1 is input a low voltage, and the gate electrodes of the triode circuits 11 of the pixels of the row corresponding to G1 are turned off. Meanwhile, the gate electrode line G2 is input a high voltage, the gate electrodes of the triode circuits 11 of the pixels of the row corresponding to G2 are turned on, the signal line H inputs a signal voltage to the pixel electrode 12 through the triode circuit 11, and the pixels of the row corresponding to G2 are charged. Respective rows of pixels are scanned and charged in turn in the row scanning mode as described above.

However, disadvantages of this row scanning mode are revealed in many application fields. Taking the shutter-glasses 3D displaying as an example, its displaying manner is as shown in FIG. 2, at a timing one, the left eye glass is turned on and the left eye picture is shown on a display; at a timing two, the right eye glass is turned on and the right eye picture is shown on the display. But, since the LCD takes the row scanning mode, when the left eye picture is to be switched to the right eye picture on the display once the timing one ends, the left eye picture and the right eye picture will exist synchronously for a long time, leading to a crosstalk. In FIG. 2, the left eye picture and the right eye picture exist synchronously for a long time during the intermediate process from the left eye picture at the timing one to the right eye picture at the timing two, which is a crosstalk. In order to reduce the influence on user experiences by the occurrence of a crosstalk, it is required to close the left eye and right eye glasses when the crosstalk occurs, which will in turn decrease the brightness of displaying. Also, the existing row scanning mode has become one of main reasons why the crosstalk is large and the brightness is low in the stereoscopic displaying. Additionally, in a naked-eye 3D displaying or a polarized-glasses 3D displaying, a frame scanning mode in which one picture can exist entirely and synchronously on the display is expected, however, it is impossible yet to provide the frame scanning mode meeting the above requirement in prior art.

### SUMMARY

In view of this, in one embodiment of the disclosure, there is provided a frame scanning method and pixel structure, array substrate and display apparatus to solve the problem that the existing row scanning mode causes the large crosstalk and low brightness in the stereoscopic displaying.

In one embodiment of the disclosure, there is provided a method for frame scanning pixel electrodes, and each pixel electrode is divided into a charging pixel electrode and a displaying pixel electrode, said method comprising: charging respective charging pixel electrodes in a row-by-row scanning mode; and charging, by the charging pixel electrodes, their corresponding displaying pixel electrodes respectively when the scanning of one frame of picture is finished.

In one example, said charging the respective charging pixel electrodes in the row-by-row scanning mode comprises: connecting the charging pixel electrodes to signal lines and first gate electrode lines through first triode circuits and connecting the gate electrodes of the first triode circuits to the first gate electrode lines, connecting the charging pixel electrodes and the displaying pixel electrodes through second triode circuits, and connecting the gate electrodes of the second triode circuits to a second gate electrode line; at a first timing, inputting a high potential to the first gate electrode line corresponding to the charging pixel electrodes of a first row, inputting a low potential to the first gate electrode lines corresponding to the charging pixel electrodes of remaining rows, inputting a low potential to the second gate electrode line, turning on the gate electrodes of the first triode circuits corresponding to the charging pixel electrodes of the first row, and charging the charging pixel electrodes of the first row by inputting signal voltages to the signal lines; at a second timing, inputting a high potential to the first gate electrode line corresponding to the charging pixel electrodes of a second row, inputting a low potential to remaining gate electrode lines, inputting a low potential to the second gate electrode line, turning on the gate electrodes of the first triode circuits corresponding to the charging pixel electrodes of the second row, and charging the charging pixel electrodes of the second row by inputting signal voltages to the signal lines; and continuing in the same way until the charging of the charging pixel electrodes of respective rows is completely finished.

In one example, said charging, by the charging pixel electrodes, their corresponding displaying pixel electrodes respectively when the scanning of one frame of picture is finished comprises: when the scanning of one frame of picture is finished, inputting a high potential to the second gate electrode line, turning on the gate electrodes of the second triode circuits, and charging, by the charging pixel electrodes, their corresponding displaying pixel electrodes through the second triode circuits.

In one example, the signal voltage input to the signal line satisfies the following condition:

$$V 1 = \frac{( {C}^{′} + C ) ( Vp 1 - Vcom ) - C ( Vp 0 - Vcom )}{{C}^{′}} + Vcom$$

wherein, C indicates the capacitance of the displaying pixel electrode, C′ indicates the capacitance of the charging pixel electrode, and V1 indicates the signal voltage input to the signal line; Vp0 indicates the voltage of the displaying pixel electrode before the displaying pixel electrode is charged by the charging pixel electrode; Vp1 indicates the voltage of the displaying pixel electrode after the displaying pixel electrode is charged by the charging pixel electrode; and Vcom indicates a common voltage.

In one example, the method further comprises: after charging, by the charging pixel electrodes, their corresponding displaying pixel electrodes respectively, forming a pixel electric field by the signal voltage on the displaying pixel electrode and the common voltage, for controlling liquid crystal molecules on the corresponding pixel to deflect, so as to realize displaying.

In another embodiment of the disclosure, there is provided a pixel structure for frame scanning, comprising a first gate electrode line, a signal line, a first triode circuit, a charging pixel electrode and a displaying pixel electrode, the first gate electrode line inputting a high or low potential to the first triode circuit; the signal line inputting a signal voltage to the first triode circuit; the first gate electrode line, the signal line and the first triode circuit charging the charging pixel electrode in a row-by-row scanning mode; the charging pixel electrode charging the displaying pixel electrode when the scanning of one frame of picture is finished; and the displaying pixel electrode being connected to the charging pixel electrode, for accepting charging by the charging pixel electrode.

In one example, the pixel structure further comprises a second triode circuit and a second gate electrode line for inputting a high or low potential to the second triode circuit, the charging pixel electrode being connected to the signal line and the first gate electrode line through the first triode circuit, the gate electrode of the first triode circuit being connected to the first gate electrode line, the charging pixel electrode and the displaying pixel electrode being connected through the second triode circuit, and the gate electrode of the second triode circuit being connected to the second gate electrode line; the first gate electrode line corresponding to the charging pixel electrodes of a first row is input a high potential at a first timing, correspondingly, the first gate electrode lines corresponding to the charging pixel electrodes of the remaining rows being input a low potential, the second gate electrode line is input a low potential, the gate electrodes of the first triode circuits corresponding to the charging pixel electrodes of the first row are turned on, and the charging pixel electrodes of the first row are charged by inputting signal voltages to the signal lines; the first gate electrode line corresponding to the charging pixel electrodes of a second row is input a high potential at a second timing, correspondingly, the first gate electrode lines corresponding to the charging pixel electrodes of the remaining rows being input a low potential, the second gate electrode line is input a low potential, the gate electrodes of the first triode circuits corresponding to the charging pixel electrodes of the second row are turned on, and the charging pixel electrodes of the second row are charged by inputting signal voltages to the signal lines; and it is continued in the same way until the charging of the charging pixel electrode of respective rows is completely finished.

In one example, the second gate electrode line is further input a high potential when the scanning of one frame of picture is finished. Correspondingly, the gate electrodes of the second triode circuits are turned on, and the charging pixel electrodes charge their corresponding displaying pixel electrodes respectively through the second triode circuits.

In one example, the signal voltage input to the signal line satisfies the following condition:

$$V 1 = \frac{( {C}^{′} + C ) ( Vp 1 - Vcom ) - C ( Vp 0 - Vcom )}{{C}^{′}} + Vcom$$

wherein, C indicates the capacitance of the displaying pixel electrode, C′ indicates the capacitance of the charging pixel electrode, and V1 indicates the signal voltage input to the signal line; Vp0 indicates the voltage of the displaying pixel electrode before the displaying pixel electrode is charged by the charging pixel electrode; Vp1 indicates the voltage of the displaying pixel electrode after the displaying pixel electrode is charged by the charging pixel electrode; and Vcom indicates a common voltage.

In one example, after the charging pixel electrode charges the displaying pixel electrode respectively, the signal voltage on the displaying pixel electrode and the common voltage form a pixel electric field, for controlling liquid crystal molecules on the corresponding pixel to deflect, so as to realize displaying.

In a further embodiment of the disclosure, there is provided an array substrate for frame scanning, comprising an array of pixels, each pixel comprising a first gate electrode line, a signal line, a first triode circuit, a charging pixel electrode and a displaying pixel electrode, the first gate electrode line inputting a high or low potential to the first triode circuit; the signal line inputting a signal voltage to the first triode circuit; the first gate electrode line, the signal line and the first triode circuit charging the charging pixel electrode in a row-by-row scanning mode; the charging pixel electrode charging the displaying pixel electrode when the scanning of one frame of picture is finished; and the displaying pixel electrode being connected to the charging pixel electrode, for accepting charging by the charging pixel electrode.

In one example, each pixel further comprises a second triode circuit and a second gate electrode line for inputting a high or low potential to the second triode circuit, the charging pixel electrode being connected to the signal line and the first gate electrode line through the first triode circuit, the gate electrode of the first triode circuit being connected to the first gate electrode line, the charging pixel electrode and the displaying pixel electrode being connected through the second triode circuit, and the gate electrode of the second triode circuit being connected to the second gate electrode line; the first gate electrode line corresponding to the charging pixel electrodes of a first row is input a high potential at a first timing, correspondingly, the first gate electrode lines corresponding to the charging pixel electrodes of the remaining rows being input a low potential, the second gate electrode line is input a low potential, the gate electrodes of the first triode circuits corresponding to the charging pixel electrodes of the first row are turned on, and the charging pixel electrodes of the first row are charged by inputting signal voltages to the signal lines; the first gate electrode line corresponding to the charging pixel electrodes of a second row is input a high potential at a second timing, correspondingly, the first gate electrode lines corresponding to the charging pixel electrodes of the remaining rows being input a low potential, the second gate electrode line is input a low potential, the gate electrodes of the first triode circuits corresponding to the charging pixel electrodes of the second row are turned on, and the charging pixel electrodes of the second row are charged by inputting signal voltages to the signal lines; and it is continued in the same way until the charging of the charging pixel electrode of respective rows is completely finished.

In one example, the second gate electrode line is further input a high potential when the scanning of one frame of picture is finished. Correspondingly, the gate electrodes of the second triode circuits are turned on, and the charging pixel electrodes charge their corresponding displaying pixel electrodes respectively through the second triode circuits.

In one example, the signal voltage input to the signal line satisfies the following condition:

$$V 1 = \frac{( {C}^{′} + C ) ( Vp 1 - Vcom ) - C ( Vp 0 - Vcom )}{{C}^{′}} + Vcom$$

wherein, C indicates the capacitance of the displaying pixel electrode, C′ indicates the capacitance of the charging pixel electrode, and V1 indicates the signal voltage input to the signal line; Vp0 indicates the voltage of the displaying pixel electrode before the displaying pixel electrode is charged by the charging pixel electrode; Vp1 indicates the voltage of the displaying pixel electrode after the displaying pixel electrode is charged by the charging pixel electrode; and Vcom indicates a common voltage.

In one example, after the charging pixel electrode charges the displaying pixel electrode respectively, the signal voltage on the displaying pixel electrode and the common voltage form a pixel electric field, for controlling liquid crystal molecules on the corresponding pixel to deflect, so as to realize displaying.

In another embodiment of the disclosure, there is provided a display apparatus comprising an array substrate, the array substrate comprising an array of pixels, each pixel comprising a first gate electrode line, a signal line, a first triode circuit, a charging pixel electrode and a displaying pixel electrode, the first gate electrode line inputting a high or low potential to the first triode circuit; the signal line inputting a signal voltage to the first triode circuit; the first gate electrode line, the signal line and the first triode circuit charging the charging pixel electrode in a row-by-row scanning mode; the charging pixel electrode charging the displaying pixel electrode when the scanning of one frame of picture is finished; and the displaying pixel electrode being connected to the charging pixel electrode, for accepting charging by the charging pixel electrode.

In one example, each pixel further comprises a second triode circuit and a second gate electrode line for inputting a high or low potential to the second triode circuit, the charging pixel electrode being connected to the signal line and the first gate electrode line through the first triode circuit, the gate electrode of the first triode circuit being connected to the first gate electrode line, the charging pixel electrode and the displaying pixel electrode being connected through the second triode circuit, and the gate electrode of the second triode circuit being connected to the second gate electrode line; the first gate electrode line corresponding to the charging pixel electrodes of a first row is input a high potential at a first timing, correspondingly, the first gate electrode lines corresponding to the charging pixel electrodes of the remaining rows being input a low potential, the second gate electrode line is input a low potential, the gate electrodes of the first triode circuits corresponding to the charging pixel electrodes of the first row are turned on, and the charging pixel electrodes of the first row are charged by inputting signal voltages to the signal lines; the first gate electrode line corresponding to the charging pixel electrodes of a second row is input a high potential at a second timing, correspondingly, the first gate electrode lines corresponding to the charging pixel electrodes of the remaining rows being input a low potential, the second gate electrode line is input a low potential, the gate electrodes of the first triode circuits corresponding to the charging pixel electrodes of the second row are turned on, and the charging pixel electrodes of the second row are charged by inputting signal voltages to the signal lines; and it is continued in the same way until the charging of the charging pixel electrode of respective rows is completely finished.

In one example, the second gate electrode line is further input a high potential when the scanning of one frame of picture is finished. Correspondingly, the gate electrodes of the second triode circuits are turned on, and the charging pixel electrodes charge their corresponding displaying pixel electrodes respectively through the second triode circuits.

In one example, the signal voltage input to the signal line satisfies the following condition:

$$V 1 = \frac{( {C}^{′} + C ) ( Vp 1 - Vcom ) - C ( Vp 0 - Vcom )}{{C}^{′}} + Vcom$$

wherein, C indicates the capacitance of the displaying pixel electrode, C′ indicates the capacitance of the charging pixel electrode, and V1 indicates the signal voltage input to the signal line; Vp0 indicates the voltage of the displaying pixel electrode before the displaying pixel electrode is charged by the charging pixel electrode; Vp1 indicates the voltage of the displaying pixel electrode after the displaying pixel electrode is charged by the charging pixel electrode; and Vcom indicates a common voltage.

In one example, after the charging pixel electrode charges the displaying pixel electrode respectively, the signal voltage on the displaying pixel electrode and the common voltage form a pixel electric field, for controlling liquid crystal molecules on the corresponding pixel to deflect, so as to realize displaying.

A frame scanning method and pixel structure, array substrate and display apparatus as provided in embodiments of the present disclosure divide one pixel electrode into a charging pixel electrode and a displaying pixel electrode which are controlled independently, the charging pixel electrodes are charged in a row-by-row scanning mode firstly, and then the charging pixel electrodes are triggered to charge the displaying pixel electrodes unanimously when the scanning of one frame of picture is finished, thus realizing the filed scanning for a display. With the embodiments of the present disclosure, one frame of picture can be displayed as a whole on a display synchronously, and the brightness in stereoscopic displaying in a row scanning mode is improved and occurrence of crosstalk in stereoscopic displaying in the row scanning mode is reduced.

### BRIEF DESCRIPTION OF THE DRAWINGS

FIG. 1 is a schematic diagram of the basic structure of a pixel of a TFT-LCD in prior art;

FIG. 2 is schematic diagram of causing a crosstalk by a row scanning mode in prior art;

FIG. 3 is a flowchart of a frame scanning method in an embodiment of the present disclosure;

FIG. 4 is a schematic diagram of a pixel structure for frame scanning in an embodiment of the present disclosure;

FIG. 5a is a schematic diagram of the voltages on a charging pixel electrode and a displaying pixel electrode before the charging pixel electrode charges the displaying pixel electrode in an embodiment of the present disclosure; and

FIG. 5b is a schematic diagram of the voltages on a charging pixel electrode and a displaying pixel electrode after the charging pixel electrode charges the displaying pixel electrode in an embodiment of the present disclosure.

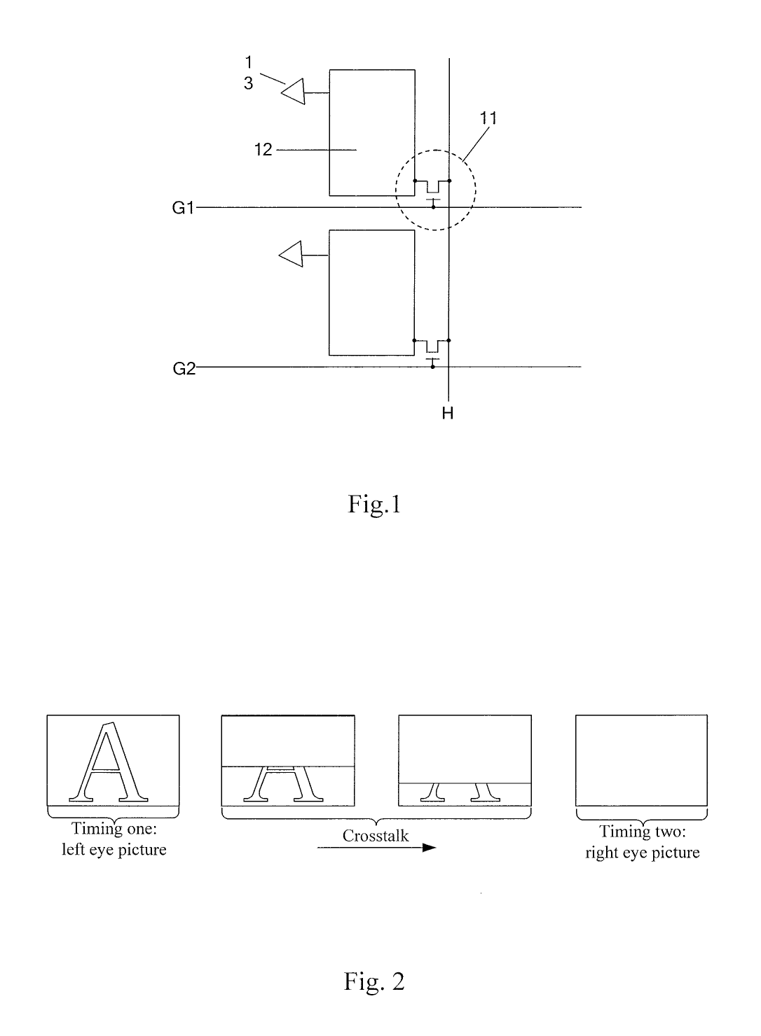

### DETAILED DESCRIPTION

In the following, the technical scheme in one embodiment of the present disclosure is further described in detail in conjunction with attached drawings and specific embodiments.

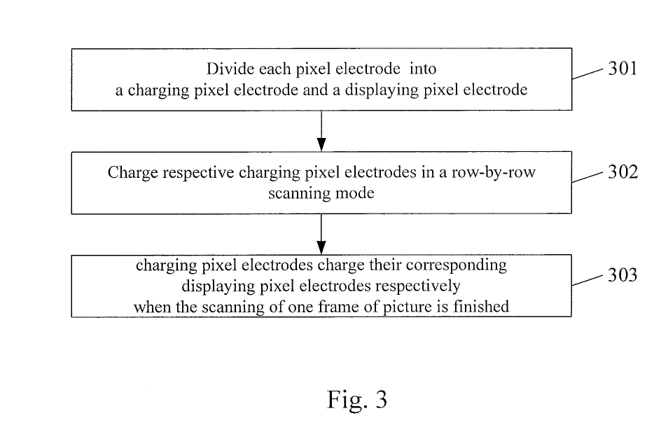

In order to solve the problem that the existing row scanning mode causes the large crosstalk and low brightness in the stereoscopic displaying and to meet the frame scanning requirement that one picture exists entirely and synchronously on a display, a frame scanning method, as shown in FIG. 3, provided in one embodiment of the disclosure mainly comprises the following steps.

At step 301, each pixel electrode is divided into a charging pixel electrode and a displaying pixel electrode.

That is, each pixel electrode is divided into a charging pixel electrode and a displaying pixel electrode, which are controlled independently, so as to realize that respective charging pixel electrodes charge their corresponding displaying pixel electrodes respectively.

At step 302, respective charging pixel electrodes are charged in a row-by-row scanning mode.

The charging pixel electrodes corresponding to respective rows of pixels are charged in turn in the row-by-row scanning mode until the charging of the charging pixel electrodes of respective rows is finished.

At step 303, when the scanning of one frame of picture is finished, the charging pixel electrodes respectively charge their corresponding displaying pixel electrodes.

The so-called “the scanning of one frame of picture is finished” refers to the completion of the scanning of the first row of pixels through the last row of pixels in turn. That is to say, when the charging of the charging pixel electrodes of respective rows is completely finished (that is, the scanning and charging of the first row of charging pixel electrodes through the last row of charging pixel electrodes are in turn completely finished), the charging pixel electrodes are triggered to charge their corresponding displaying pixel electrodes respectively. It is needed to explain that the number of rows of pixels corresponding to one frame of picture is not fixed, which is determined by the size of a display panel.

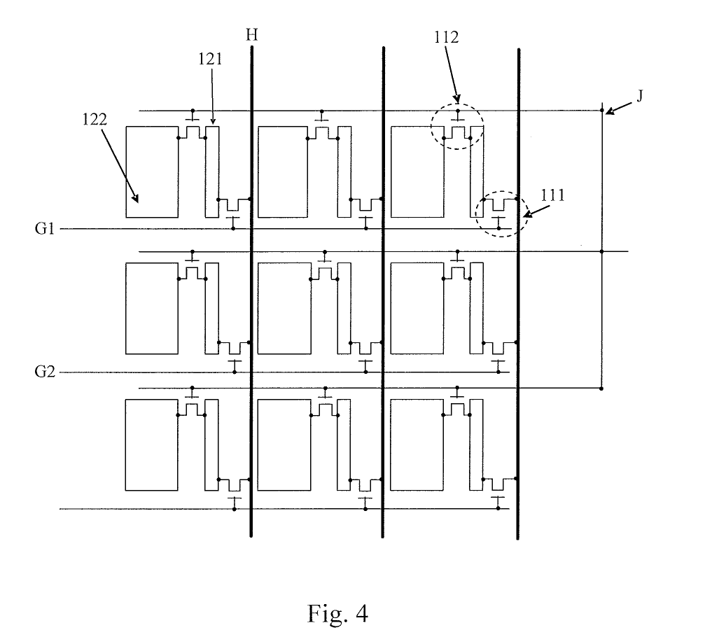

Corresponding to the frame scanning method as described above, a pixel structure for frame scanning as provided in one embodiment of the present disclosure, as shown in FIG. 4, mainly comprises a first gate electrode lines (as shown by G1, G2 in the figure, G1 indicating the first gate electrode line corresponding to the first row of pixels and G2 indicating the first gate electrode line corresponding to the second row of pixels), a signal line H, a first triode circuit (as shown by 111 in the figure), a charging pixel electrode 121 and a displaying pixel electrode 122.

Wherein, the first gate electrode line is used for inputting a high or low potential to the first triode circuit.

The signal line H is used for inputting a signal voltage for the first triode circuit.

The first gate electrode line, the signal line H and the first triode circuit charge the charging pixel electrode 121 in a row-by-row scanning mode.

The charging pixel electrode 121 is used for charging the corresponding displaying pixel electrodes 122 when the scanning of one frame of picture is finished.

The displaying pixel electrode 122 is connected to the corresponding charging pixel electrodes 121, for accepting charging by the charging pixel electrode 121.

Further, pixel structure further comprises a second triode circuit 112 and a second gate electrode line (as shown by J in the figure) for inputting a high or low potential to the second triode circuit; the charging pixel electrode 121 is connected to the signal line H and the first gate electrode line through the first triode circuit 111, and the gate electrode of the first triode circuit 111 is connected to the first gate electrode line; the charging pixel electrode 121 and the displaying pixel electrode 122 are connected with each other through the second triode circuit 112, and the gate electrode of the second triode circuit 112 is connected to the second gate electrode line J.

Accordingly, the process of charging respective charging pixel electrodes in the row-by-row scanning mode is specifically as follows.

At a first timing, the first gate electrode line (i.e. the first gate electrode line G1 for the first row) corresponding to the charging pixel electrodes 121 of the first row is input a high potential, remaining first gate electrode lines are input a low potential, the second gate electrode line J is input a low potential, the gate electrodes of the first triode circuits 111 corresponding to the charging pixel electrodes 121 of the first row are turned on, and the signal lines H are input signal voltages and charge the charging pixel electrodes 121 of the first row.

At a second timing, the first gate electrode line (i.e. the first gate electrode line G2 for the second row) corresponding to the charging pixel electrodes 121 of the second row is input a high potential, remaining first gate electrode lines are input a low potential, the second gate electrode line J is input a low potential, the gate electrodes of the first triode circuits 111 corresponding to the charging pixel electrodes 121 of the second row are turned on, and the signal lines H are input signal voltages and charge the charging pixel electrodes 121 of the second row.

It is continued in the same way, until the charging of the charging pixel electrodes of respective rows is finished, that is, the scanning and charging of the charging pixel electrodes 121 of the first row through the charging pixel electrodes 121 of the last row are in turn completely finished, which is also referred to be as “the scanning of one frame of picture is finished” here. It is needed to explain that the number of rows corresponding to one frame of picture is not fixed and is determined by the size of a display panel.

Furthermore, when the scanning of one frame of picture is finished, the second gate electrode line J is input a high potential, the gate electrodes of the second triode circuits 112 are turned on, the charging pixel electrodes 121 charge their corresponding displaying pixel electrodes 122 respectively through the second triode circuits 112.

After the charging pixel electrodes 121 charge their corresponding displaying pixel electrodes 122 respectively, the signal voltage on a displaying pixel electrode 122 and the common voltage on the common electrode may form a pixel electric field which controls the liquid crystal molecules on the corresponding pixel to deflect, thus displaying is realized. Since it is after the scanning of one frame of picture is finished that the charging pixel electrodes are triggered to charge the displaying pixel electrodes simultaneously, a full picture can be displayed as a whole on a display simultaneously.

It is needed to explain that, in order to employ the pixel structure in one embodiment of the present disclosure to realize frame scanning, the original signal voltage (i.e. the signal voltage input to the signal line H) is further required to be processed correspondingly, which will be specifically analyzed below.

When charging the displaying pixel electrodes, there are two processes as follows:

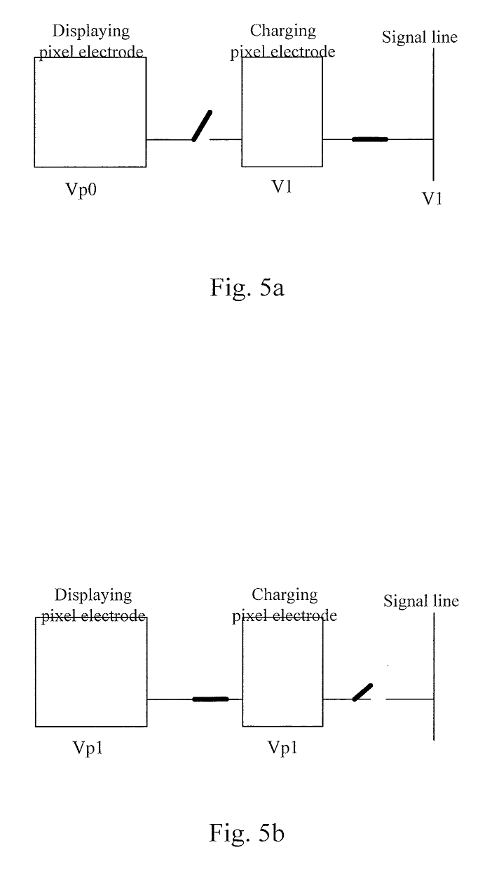

1. The gate electrode of the first triode circuit 111 is turned on, the signal line charges the charging pixel electrode, the process of which is as shown in FIG. 5a. After the signal line finishes charging the charging pixel electrode, the voltage on the charging pixel electrode is the same as that on the signal line and is denoted by V1, and the voltage on the displaying pixel electrode is denoted by Vp0.

2. The gate electrode of the second triode circuit 112 is turned on, the charging pixel electrode charges the displaying pixel electrode, the process of which is as shown in FIG. 5b. After the charging pixel electrode finishes charging the displaying pixel electrode, the voltage on the charging pixel electrode is the same as that on the displaying pixel electrode and is denoted by Vp1.

Then, according to

$$C = \frac{Q}{V}$$

and assuming that there is no loss in amount of electricity in the process that the gate electrode of the second triode circuit 112 is turned on, it can be obtained that:

C′(V1−Vcom)+C(Vp0−Vcom)=Q=(C′+C)(Vp1−Vcom),

and consequently,

$$V 1 = \frac{( {C}^{′} + C ) ( Vp 1 - Vcom ) - C ( Vp 0 - Vcom )}{{C}^{′}} + Vcom .$$

Wherein, Q indicates the amount of electricity; C indicates the capacitance of the displaying pixel electrode, C′ indicates the capacitance of the charging pixel electrode, and the values of C and C′ are both determined by the property of the pixel structure itself; V1 indicates the signal voltage input to the signal line; Vp0 indicates the voltage of the displaying pixel electrode before the displaying pixel electrode is charged by the charging pixel electrode; Vp1 indicates the voltage of the displaying pixel electrode after the displaying pixel electrode is charged by the charging pixel electrode; and Vcom indicates the common voltage.

The value of the signal voltage V1 input to the signal line is the value determined by dividing the difference between (C′+C)(Vp1−Vcom) and C(Vp0−Vcom) by C′ and then adding to Vcom.

In addition, in one embodiment of the present disclosure, there is also provided an array substrate comprising the pixel structure for frame scanning shown in FIG. 4, the respective components and their specifically implemented functions of which are the same as those shown in FIG. 4 and will not be described here.

In one embodiment of the present disclosure, there is also provided a display apparatus using the above array substrate that also comprises the pixel structure for frame scanning shown in FIG. 4, the respective components and their specifically implemented functions of which are the same as those shown in FIG. 4 and will not be described here.

To sum up, in one embodiment of the present disclosure, by dividing one pixel electrode into a charging pixel electrode and a displaying pixel electrode which are controlled independently, charging the charging pixel electrode in a row-by-row scanning mode firstly, and then triggering the charging pixel electrodes to charge the displaying pixel electrodes unanimously, a frame scanning that a full picture appears on a display simultaneously is realized. In one embodiment of the present disclosure, for a shutter-glasses 3D displaying, a polarized-glasses 3D displaying in which a liquid crystal box is used to modulate the direction of the polarized light, and a naked-eye 3D displaying in which the controls such as scan tracing, scanning and so on are needed to be performed, the frame scanning method and the pixel structure can improve the brightness of stereoscopic displaying in the row scanning mode and avoid a crosstalk in the stereoscopic displaying in the row scanning mode.

The described above is only some embodiments of the present disclosure and is not used to limit the protection scope of the present disclosure.

What is claimed is:

1. A method for frame scanning pixel electrodes, each pixel electrode being divided into a charging pixel electrode and a displaying pixel electrode, said method comprising:
charging respective charging pixel electrodes in a row-by-row scanning mode; and
charging, by the charging pixel electrodes, their corresponding displaying pixel electrodes respectively when the scanning of one frame of picture is finished.

2. The method according to claim 1, wherein said charging the respective charging pixel electrodes in the row-by-row scanning mode comprises:
connecting the charging pixel electrodes to signal lines and first gate electrode lines through first triode circuits and connecting the gate electrodes of the first triode circuits to the first gate electrode lines, connecting the charging pixel electrodes and the displaying pixel electrodes through second triode circuits, and connecting the gate electrodes of the second triode circuits to a second gate electrode line;
at a first timing, inputting a high potential to the first gate electrode line corresponding to the charging pixel electrodes of a first row, inputting a low potential to the first gate electrode lines corresponding to the charging pixel electrodes of remaining rows, inputting a low potential to the second gate electrode line, turning on the gate electrodes of the first triode circuits corresponding to the charging pixel electrodes of the first row, and charging the charging pixel electrodes of the first row by inputting signal voltages to the signal lines;
at a second timing, inputting a high potential to the first gate electrode line corresponding to the charging pixel electrodes of a second row, inputting a low potential to the first gate electrode lines corresponding to the charging pixel electrodes of remaining rows, inputting a low potential to the second gate electrode line, turning on the gate electrodes of the first triode circuits corresponding to the charging pixel electrodes of the second row, and charging the charging pixel electrodes of the second row by inputting signal voltages to the signal lines; and
continuing in the same way until the charging of the charging pixel electrodes of respective rows is completely finished.

3. The method according to claim 2, wherein said charging, by the charging pixel electrodes, their corresponding displaying pixel electrodes respectively when the scanning of one frame of picture is finished comprises:
when the scanning of one frame of picture is finished, inputting a high potential to the second gate electrode line, turning on the gate electrodes of the second triode circuits, and charging, by the charging pixel electrodes, their corresponding displaying pixel electrodes through the second triode circuits.

4. The method according to claim 2, wherein the signal voltage input to the signal line satisfies the following condition:
$$V 1 = \frac{( {C}^{′} + C ) ( Vp 1 - Vcom ) - C ( Vp 0 - Vcom )}{{C}^{′}} + Vcom$$
wherein, C indicates the capacitance of the displaying pixel electrode, C′ indicates the capacitance of the charging pixel electrode, and V1 indicates the signal voltage input to the signal line; Vp0 indicates the voltage of the displaying pixel electrode before the displaying pixel electrode is charged by the charging pixel electrode; Vp1 indicates the voltage of the displaying pixel electrode after the displaying pixel electrode is charged by the charging pixel electrode; and Vcom indicates a common voltage.

5. The method according to claim 1, further comprising:
after charging, by the charging pixel electrodes, their corresponding displaying pixel electrodes respectively, forming a pixel electric field by the signal voltage on the displaying pixel electrode and the common voltage, for controlling liquid crystal molecules on the corresponding pixel to deflect, so as to realize displaying.

6. An array substrate for frame scanning, comprising an array of pixels, each pixel comprising a first gate electrode line, a signal line, a first triode circuit, a charging pixel electrode and a displaying pixel electrode,
the first gate electrode line inputting a high or low potential to the first triode circuit;
the signal line inputting a signal voltage to the first triode circuit;
the first gate electrode line, the signal line and the first triode circuit charging the charging pixel electrode in a row-by-row mode;
the charging pixel electrode charging the displaying pixel electrode when the scanning of one frame of picture is finished; and
the displaying pixel electrode being connected to the charging pixel electrode, for accepting charging by the charging pixel electrode.

7. The array substrate according to claim 6, wherein each pixel further comprises a second triode circuit and a second gate electrode line for inputting a high or low potential to the second triode circuit, the charging pixel electrode being connected to the signal line and the first gate electrode line through the first triode circuit, the gate electrode of the first triode circuit being connected to the first gate electrode line, the charging pixel electrode and the displaying pixel electrode being connected through the second triode circuit, and the gate electrode of the second triode circuit being connected to the second gate electrode line;
the first gate electrode line corresponding to the charging pixel electrodes of a first row being input a high potential at a first timing, correspondingly, the first gate electrode lines corresponding to the charging pixel electrodes of the remaining rows being input a low potential, the second gate electrode line being input a low potential, the gate electrodes of the first triode circuits corresponding to the charging pixel electrodes of the first row being turned on, and the charging pixel electrodes of the first row being charged by inputting signal voltages to the signal lines;
the first gate electrode line corresponding to the charging pixel electrodes of a second row being input a high potential at a second timing, correspondingly, the first gate electrode lines corresponding to the charging pixel electrodes of the remaining rows being input a low potential, the second gate electrode line being input a low potential, the gate electrodes of the first triode circuits corresponding to the charging pixel electrodes of the second row being turned on, and the charging pixel electrodes of the second row being charged by inputting signal voltages to the signal lines; and
it is continued in the same way until charging the charging pixel electrode of respective rows is completely finished.

8. The array substrate according to claim 7, wherein the second gate electrode line further being input a high potential when the scanning of one frame of picture is finished,
correspondingly, the gate electrodes of the second triode circuits being turned on, and the charging pixel electrodes charging their corresponding displaying pixel electrodes respectively through the second triode circuits.

9. The array substrate according to claim 6, wherein the signal voltage input to the signal line satisfies the following condition:
$$V 1 = \frac{( {C}^{′} + C ) ( Vp 1 - Vcom ) - C ( Vp 0 - Vcom )}{{C}^{′}} + Vcom$$
wherein, C indicates the capacitance of the displaying pixel electrode, C′ indicates the capacitance of the charging pixel electrode, and V1 indicates the signal voltage input to the signal line; Vp0 indicates the voltage of the displaying pixel electrode before the displaying pixel electrode is charged by the charging pixel electrode; Vp1 indicates the voltage of the displaying pixel electrode after the displaying pixel electrode is charged by the charging pixel electrode; and Vcom indicates a common voltage.

10. The array substrate to claim 6, wherein after the charging pixel electrodes charges the displaying pixel electrode, the signal voltage on the displaying pixel electrode and the common voltage form a pixel electric field, for controlling liquid crystal molecules on the corresponding pixel to deflect, so as to realize displaying.

11. A display apparatus comprising an array substrate, the array substrate comprising an array of pixels, each pixel comprising a first gate electrode line, a signal line, a first triode circuit, a charging pixel electrode and a displaying pixel electrode,
the first gate electrode line inputting a high or low potential to the first triode circuit;
the signal line inputting a signal voltage to the first triode circuit;
the first gate electrode line, the signal line and the first triode circuit charging the charging pixel electrode in a row-by-row mode;
the charging pixel electrode charging the displaying pixel electrode when the scanning of one frame of picture is finished; and
the displaying pixel electrode being connected to the charging pixel electrode, for accepting charging by the charging pixel electrode.

12. The display apparatus according to claim 11, wherein each pixel further comprises a second triode circuit and a second gate electrode line for inputting a high or low potential to the second triode circuit, the charging pixel electrode being connected to the signal line and the first gate electrode line through the first triode circuit, the gate electrode of the first triode circuit being connected to the first gate electrode line, the charging pixel electrode and the displaying pixel electrode being connected through the second triode circuit, and the gate electrode of the second triode circuit being connected to the second gate electrode line;
the first gate electrode line corresponding to the charging pixel electrodes of a first row being input a high potential at a first timing, correspondingly, the first gate electrode lines corresponding to the charging pixel electrodes of the remaining rows being input a low potential, the second gate electrode line being input a low potential, the gate electrodes of the first triode circuits corresponding to the charging pixel electrodes of the first row being turned on, and the charging pixel electrodes of the first row being charged by inputting signal voltages to the signal lines;
the first gate electrode line corresponding to the charging pixel electrodes of a second row being input a high potential at a second timing, correspondingly, the first gate electrode lines corresponding to the charging pixel electrodes of the remaining rows being input a low potential, the second gate electrode line being input a low potential, the gate electrodes of the first triode circuits corresponding to the charging pixel electrodes of the second row being turned on, and the charging pixel electrodes of the second row being charged by inputting signal voltages to the signal lines; and
it is continued in the same way until charging the charging pixel electrode of respective rows is completely finished.

13. The display apparatus according to claim 12, wherein the second gate electrode line further being input a high potential when the scanning of one frame of picture is finished,
correspondingly, the gate electrodes of the second triode circuits being turned on, and the charging pixel electrodes charging their corresponding displaying pixel electrodes respectively through the second triode circuits.

14. The display apparatus according to claim 11, wherein the signal voltage input to the signal line satisfies the following condition:
$$V 1 = \frac{( {C}^{′} + C ) ( Vp 1 - Vcom ) - C ( Vp 0 - Vcom )}{{C}^{′}} + Vcom$$
wherein, C indicates the capacitance of the displaying pixel electrode, C′ indicates the capacitance of the charging pixel electrode, and V1 indicates the signal voltage input to the signal line; Vp0 indicates the voltage of the displaying pixel electrode before the displaying pixel electrode is charged by the charging pixel electrode; Vp1 indicates the voltage of the displaying pixel electrode after the displaying pixel electrode is charged by the charging pixel electrode; and Vcom indicates a common voltage.

15. The display apparatus to claim 11, wherein after the charging pixel electrodes charges the displaying pixel electrode, the signal voltage on the displaying pixel electrode and the common voltage form a pixel electric field, for controlling liquid crystal molecules on the corresponding pixel to deflect, so as to realize displaying.
